(19) United States
(12) Patent Application Publication
(10) Pub. No.: US 2026/0244723 A1
(43) Pub. Date: Aug. 20, 2026

(54) BIOMETRIC AUTHENTICATION SYSTEM AND METHOD

(71) Applicant: Northrop Grumman Systems Corporation, Falls Church, VA (US)

(72) Inventor: Jessica Ascough, Redondo Beach, CA (US)

(21) Appl. No.: 19/055,130

(22) Filed: Feb. 17, 2025

(51) Int. Cl. G06F 21/32

(52) U.S. Cl. CPC G06F 21/32

(57) ABSTRACT

A biometric authentication system and method are disclosed in which an imaging specification is randomly selected from a plurality previously generated imaging specifications. Each of the plurality of previously generated imaging specifications specifies a quantity of emissions by the light emitter, an intensity associated with each emission, a duration of each emission, and an interval free of emission following each emission, all of which are randomly determined. A light emitter is operated to emit the quantity of emissions in accordance with the selected imaging specification and an imaging device is used to acquire an authentication image of an operator of the computing device after operation of the light emitter is completed. The authentication image is analyzed in accordance with a previously developed biometric template associated with the selected imaging specification to determine if the authentication image and the biometric template are both associated with the operator.

### FIELD OF DISCLOSURE

The present subject matter relates to systems and methods for authenticating the identity of an operator of a computing device and more particularly, a system and methods for biometric authentication of an operator of a mobile computing device.

### BACKGROUND

Computing devices such as desktop or laptop computers, smartphones, tablets, and the like are routinely used to carry sensitive information and/or provide authentication services that verify an identity of an authorized operator of such device who seeks access to sensitive information either stored on the computing device or a remote storage device. Such sensitive information may include, for example, financial and healthcare information, business documents, identity documents, and the like. Before computing devices became ubiquitous for storing and/or accessing such information, access to sensitive information required authentication in the presence of an authorized officer (such as a guard, bank employee, a medical employee, etc.) responsible for securing such information or access. In contrast, current computing devices may use a biometric authentication method such as a fingerprint scan, facial scan, iris scan, and the like to confirm that the operator of the computing device has access to the computing device, information stored on the computing device, and/or a remote storage location, is indeed authorized for such access and is not a bad actor (e.g., an identity thief) who is assuming the identity of the authorized user for nefarious purposes. Confirming that such operator is a living human may be challenging in situations in which authentication is undertaken only electronically by the computing device without requiring the operator to be in the presence of an authorized officer. For example, biometric features associated with an operator may not remain constant over the lifetime thereof because facial features, fingerprints, retinas, sclera, and the like may change due to aging, injury, disease and the like. Further, in some cases, physical features used for biometric authentication may not be sufficiently unique to an individual. For example, identical twins may have physical features sufficiently similar to confuse an authentication system.

Further, typical biometric authentication systems cannot verify that the physical feature is indeed that of a human being and not a computer generated model (i.e., a high-resolution image or video) that may be able to spoof the conventional biometric authentication system. In addition, even if such physical feature is not fake, the typical biometric authentication system may not be able to verify that the person associated with the physical feature is alive when such feature is presented for authentication. For example, in cases where the information sought is particularly sensitive or valuable, a bad actor may use a cadaver or a severed body part (e.g., finger or thumb, eyeball, and the like) of the authorized user to provide the fingerprint, facial scan, iris scan, or other feature to the typical biometric authentication system to gain access to the sensitive information being sought.

### SUMMARY

According to one aspect, a biometric authentication system for a computing device includes a light emitter, an imaging device, and a controller comprising a processor and memory architecture. The controller is configured to randomly select an imaging specification from a plurality of previously generated imaging specifications. Each of the plurality of previously generated imaging specifications specifies a quantity of emissions by the light emitter, an intensity and duration associated with each emission, and an interval free of emission following each emission, all of which are randomly determined. The controller is also configured to operate the light emitter to emit the quantity of emissions in accordance with the selected imaging specification, acquire using the imaging device an authentication image of an operator of the computing device after operation of the light emitter is completed, and analyze the authentication image in accordance with a previously developed biometric template associated with the selected imaging specification to determine if the authentication image and the biometric template are both associated with the operator.

According to another aspect, a method of biometric authentication of an operator of a computing device includes randomly selecting an imaging specification from a plurality previously generated imaging specifications. Each of the plurality of previously generated imaging specifications specifies a quantity of emissions by a light emitter, an intensity and duration of each emission, and an interval free of emission following each emission, all of which are randomly determined. The method further includes operating the light emitter to emit the quantity of emissions in accordance with the selected imaging specification, using an imaging device to acquire an authentication image after operation of the light emitter in accordance with the selected imaging specification is completed, and analyzing the authentication image in accordance with a previously developed biometric template associated with the selected imaging specification to determine if the authentication image and the biometric template are both associated with the operator.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a partial planar view of a computing device secured by a biometric authentication system of the present disclosure;

FIG. 2 is a block diagram of the biometric authentication system of FIG. 1;

FIG. 3 is a flowchart of steps undertaken by a training module of the biometric authentication system of FIG. 1;

FIG. 4 is a flowchart of steps undertaken by the training module of the biometric authentication system of FIG. 1 to create a biometric template; and

FIG. 5 is a flowchart of steps undertaken by an authentication module of the biometric authentication system of FIG. 1 to authenticate an operator of the computing device of FIG. 1.

### DETAILED DESCRIPTION

Disclosed herein is a biometric authentication system to confirm that an operator of a computer device who is representing themselves as an authorized user is indeed such user, is human, and alive. In particular, the biometric authentication system uses static features of the operator's iris and dynamic responses of the iris to stimuli to confirm the operator is indeed the authorized user and alive. The human iris is particularly suited for biometric authentication because the patterns of the human iris are unique to the individual and even irises of each eye of a person are not identical, the pattern of the iris does not change as the person ages or from disease, and the like. Further, the human iris may include up to 250 features such as contraction furrows, radial furrows, collarettes, crypts, pigment spots and variations, a ciliary zone, a pupillary zone, and the like. In addition, the iris is an eye muscle that regulates a size of the pupil in response to stimulation by light. As discussed in greater detail below, such features of the human iris may be used to verify the identity and liveness of the operator.

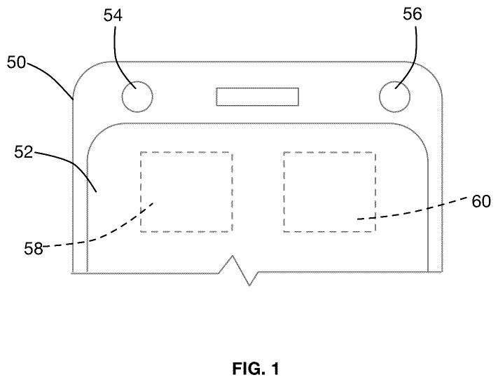

Referring to FIG. 1, a biometric authentication system (BAS) operates on a computing device 50 such as a desktop computer, a laptop computer, a smartphone, a tablet computer, and the like. The computing device may include a touch screen display 52 (or other input/output components) that enables the operator of the computing device 50 to interact with the computing device to request and view information stored thereon or from a remote computing device to which the computing device 50 is connected. The computing device 50 may be connected to the remote device by a communications network such as, for example, a wired or a wireless network, a cellular network, a public network such as the Internet, a private network such as a virtual private network, and the like. However, it should be noted that the computing device 50 does not have to be connected to any remote device or communications network for the BAS to operate. For example, most of the biometric authentication functions of the BAS do not require access to a network and the BAS may operate to prevent unauthorized access to the computing device 50 even if the computing device 50 has network services turned off (e.g., as in “airplane mode”) or if no network is available. Those functions BAS that require network communications with a remote device may be postponed until the network is available. The computing device 50 also includes a light emitter 54 and an imaging device 56, for example, a camera. The light emitter 54 may be a source of visible light, near infrared light, infrared light, and the like. In some embodiments, the light emitter 54 is a near infrared light emitter. In such embodiments, the imaging device 56 may include an infrared filter incorporated therein so images acquired using the imaging device 56 represent elements in the field of the view of the imaging device 56 that emit or reflect infrared (including near infrared) light. In some embodiments, the light emitter 54 and the imaging device 56 are integrated components of the computing device 50. In other embodiments, one or more of the light emitter 54 and the imaging device 56 may be accessories coupled to the computing device 50 for use with the BAS.

The computing device 50 has a processor and memory architecture comprising one or more processors 58 and one or more memory modules 60. The one or more memory modules 60 may have stored therein data and instructions to cause the one or more processors 58 to undertake the functions of the BAS described herein. Further, the one or more memory modules 60 may store data secured by the BAS so that only an authorized operator of the computing device 50 is allowed access thereto. In some embodiments, the data and instructions to cause the one or more processors 58 to undertake the functions of the BAS may be encapsulated as an application program (“app’) that can be downloaded and stored in one or more memory modules 60.

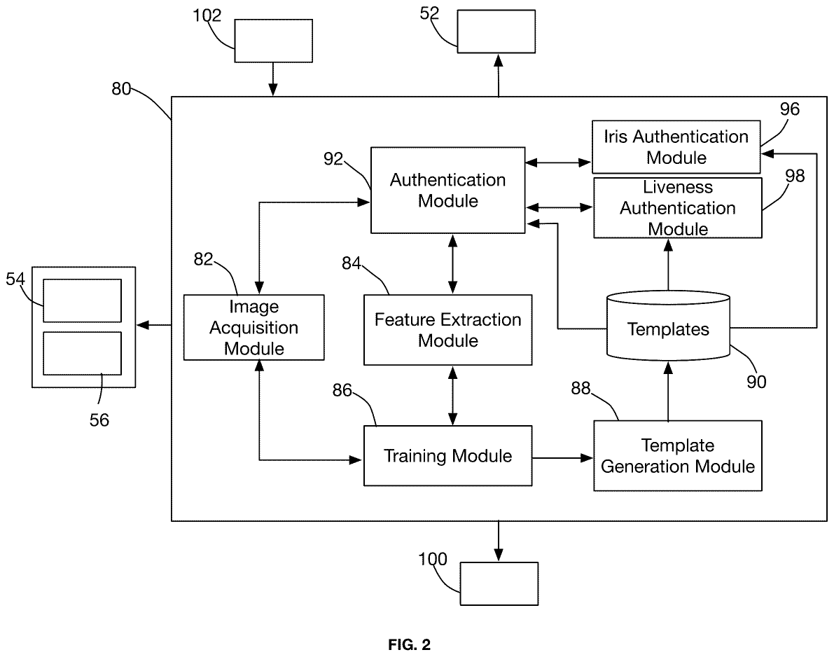

Referring to FIG. 2, in one embodiment, the BAS 80 includes an image acquisition module 82, a feature extraction module 84, a training module 86, a template generation module 88, and a template database 90. The BAS 80 further includes an authentication module 92, an iris authentication module 96, and a liveness detection module 98. The image acquisition module 82 controls the light emitter 54 and the imaging device 56 to acquire an image of the operator using a particular imaging specification (described in greater detail below) and the feature extraction module 84 analyzes the acquired image to identify particular features of one or more eyes of the operator represented in such image. The training module 86 directs the image acquisition module 84 to acquire a plurality of training images and the template generation module 88 to develop and store a plurality of templates developed from the plurality of training images in the template database 90. Each of the plurality of templates is associated with one of the imaging specifications and encodes the features identified by the feature extraction module 84 in a training image acquired in accordance with such imaging specification. Thereafter, the authentication module 92 iteratively verifies the identity and liveness of the operator of the computing device 50 while the computing device 50 is being used. In each iteration, the authentication module 92 directs the image acquisition module 82 to acquire an authentication image in accordance with a randomly selected imaging specification and directs the feature extraction module 84 to identify features represented in the acquired authentication image, directs the iris authentication module 96 to determine if irises represented in the authentication image are associated with the authorized operator of the computing device 50, and directs the liveness authentication module 98 to determine if the irises represented in the authentication image belong to a living person. In some embodiments, the authentication module 92 ceases operation of the computing device if the irises represented in the authentication image are determined to not be those of the authorized operator or if the irises represented in the authentication image are determined to not be those of a living person. In other embodiments, the authentication module 98 may generate and transmit a message to alert a system or computer 100 remote from the computing device 50 that the computing device 50 is being accessed by an unauthorized operator before ceasing operation of the computing device 50. For example, the BAS 80 may periodically confirm the identity of the person using the computing device 50 and will generate and transmit a message to the alert the system or computer 100 if for example if the person using the device is not the authorized user. For example, such a message may be generated if the unauthorized operator forces the living authorized user to authenticate the computing device 50 to unlock the computing device and then attempts to use the computing device 50 away from the living authorized user.

Before the BAS 80 may be used to verify the identity and liveness of the operator, a training module 86 of the BAS 80 is used to train the BAS 80 with characteristics of biometric features associated with the operator. Such training is comparable to “enrolling” a user authenticated by a conventional biometric authentication system.

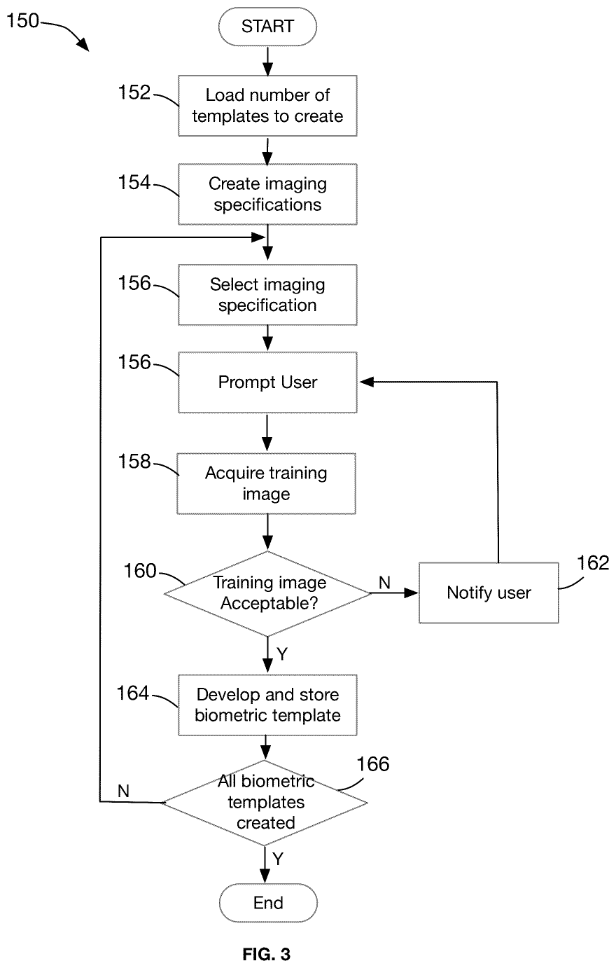

FIG. 3 shows a flowchart 150 of the steps undertaken by the BAS 80 to train the BAS 80 to be able to verify the identity and liveness of the operator of the computing device 50. Referring to FIGS. 1-3, at step 152 the training module 86 loads from the memory module 60 a predetermined value that represents how many biometric templates should be created. Such predetermined value may be configured by the creator of the BAS 80 or selected by entity associated with the computing device 50. At step 154, the training module 86 develops a plurality of imaging specifications. One imaging specification is created for each biometric template that will be developed and specifies a number of pulses of light that are emitted by the light emitter 54, a duration and intensity of each such emission, and a duration of an interval following each pulse before a subsequent pulse is emitted or the image is acquired. The number of emissions, the duration and intensity of each emission, and the duration of each interval are randomly determined. Further, the training module 86, also at step 154, confirms that the combination of the number of pulses, the duration and intensity of each pulse, and the duration of each interval specified by one imaging specification is not identical to such combination associated with any other of the plurality of imaging specifications. In some embodiments, the duration of each interval at least approximately 250 milliseconds to allow the pupil to react to the pulse preceding such interval. In some cases, the wavelength of light emitted during each pulse is between approximately 800 and approximately 950 nanometers. In some cases, the frequency of pulses may be a few hundred Hertz to a few Kilohertz, and the duration of each pulse may be nanoseconds to microseconds to minimize blur but may be greater (i.e., milliseconds) in certain (e.g., low light) situations.

At step 156, the training module 86 selects one of the imaging specifications of the plurality of imaging specifications developed at step 154. At step 156, the training module 86 prompts the user to look at the imaging device 56 or display 52 of the computing device 50. The prompt may include one or more of a visual prompt (such as text or an image) displayed on the display 52 of the computing device 50, a tactile prompt using haptic hardware (not shown) of the computing device 50, an audible prompt using a speaker (not shown) of the computing device 50, and the like.

At step 158, the training module 86 directs the image acquisition module 82 to emit pulses of light from the light emitter 54 in accordance with the selected imaging specification and then acquire a corresponding training image using the imaging device 56. At step 160, the training module 86 checks that the training image acquired at step 158 is acceptable. That is, that the acquired training image has sufficient resolution, contrast, and other imaging characteristics and that the iris(es) of one or both of the operator's eye(s) are represented in such training image. If the quality of the training image is not sufficient and/or iris(es) are not represented in the training image, the training module 86 notifies the user at step 162 and returns to step 156 to re-prompt the user and acquire another training image.

If the training module 86 determines the training image acquired at step 158 is acceptable, the training module 86, at step 164, directs the template generation module 86 to develop a biometric template from the training image acquired at step 158 as described in greater detail below. Also at step 164, the biometric template and information regarding the selected imaging specification used to acquire the training image that resulted in the biometric template are stored in the template database 90. In some embodiments, the template database 90 is a portion of the one or more memory modules 60 that comprise a trust zone (e.g., a trusted execution environment, a trusted platform module, a secure enclave, and the like) of the computing device 50 and thus cannot be readily accessed or modified by an unauthorized operator of such computing device. In some embodiments, the biometric templates are encrypted using an encryption key associated with the BAS 80. In such cases, one or both of the encryption key and/or the encrypted templates are stored in the trust zone. In some embodiments, a plurality of templates may be generated to capture changes in the iris and the pupil due to changes in environmental factors such as, for example, changes in lighting, dust, glare, eye movement, and the like. In some embodiments, an encrypted copy biometric template may also be stored on a computing device remote from the computing device for back up purposes. In some embodiments, the BAS 80 develops between 3 and 5 biometric templates. In other embodiments, the BAS 80 may develop more or fewer biometric templates.

In some embodiments, the biometric template may be generated from an iris image by, for example, applying a Daugman's Model to normalize the iris image, applying a Hough Transform to the normalized image to create a segmented image, applying Gabor Wavelets to extract features from the segmented image, and convert and compress the extracted features to store as a biometric template. The generated biometric templates may be stored using a vector or numerical embedding in addition to as an image in some embodiments.

Thereafter, at step 166, the training module 86 determines if biometric templates have been created for all of the imaging specifications developed at step 154. If there is at least one imaging specification for which a biometric template has not yet been created, processing returns to step 156 to select such imaging specification. Otherwise, the training module 86 exits.

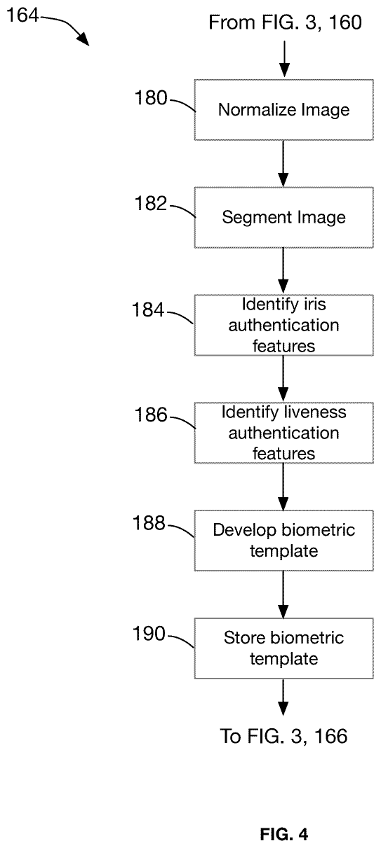

FIG. 4 shows a flowchart of the processing undertaken by the training module 86 at step 164 of FIG. 3 to develop and store a biometric template from the training image acquired at step 158 (FIG. 3). In particular, the training module 86 directs the feature extraction module 84 to identify and classify iris authentication and liveness authentication characteristics of one or more irises represented in the training image to develop the biometric template. Referring to FIG. 4, at step 180, the feature extraction module 84 normalizes (i.e., resizes and rotates) the training image so a diameter of the iris represented in the segmented image spans a predetermined number of pixels and that a major axis of a representation of the eye in the segmented image is aligned with a horizontal axis of the training image. Further, in some embodiments, also at step 180, to normalize the captured image, the feature extraction module 84 retains red, green, blue (RGB) color values and maintains and enhances color features in the image, reduces noise (e.g., by applying a Gaussian Blur filter, and the like) to maintain texture of the image, maps the shape of the iris to a standard shape and size by applying, for example, a Hough Circle Transform and other signal processing methods that detect pupil and iris boundaries.

At step 182, the feature extraction module 84 applies image processing and computer vision techniques that would be apparent to one who has ordinary skill in the art to develop a segmented image from the training image. For example, the training image may be processed detect boundaries of the iris region represented in the training image, localize such boundaries to separate the iris region from the sclera and the pupil, and isolate the iris via masking, and the like.

In some embodiments, at step 184, the feature extraction module 84 may also use edge detection, shape detection, flood fill, and similar operations to identify iris authentication features associated with each eye represented in the segmented image. In particular, the feature extraction module 84 identifies locations within the iris and dimensions of features that may be found in the iris. As many as 250 features may be available for extraction and include, for example, one or more of contraction furrows, one or more radial furrows, one or more collarettes, one or more crypts, one or more ciliary zones, one or more striations, variation in color, and other static or constant characteristics unique to each iris of the operator and represented in the segmented image. At step 184, the feature extraction module 84 analyze color histograms and color moments of the segmented image to develop distribution and statistical measures (e.g., mean, variance, skew, and the like), respectively, associated with the segmented image. At step 186, the feature extraction module 84 analyzes the segmented image to develop liveness authentication features that include characteristics of each eye of the operator that may vary in response to light stimulation (i.e., are dynamic features). Such liveness authentication features may include one or more of a circularity of the pupil and/or the iris, a diameter and/or area of the pupil relative to a diameter and/or area of the iris, portion of the eye covered by one or both upper and lower eye lids (i.e., how open the eye is), maximum and/or minimum distance between the upper and lower eye lids, and the like. In some embodiments, determining the static and/or dynamic features may also include determining of one or more of eye blinking, shifting, squinting, twitching, esotropia (eyes pointing inward toward nose), exotropia (eyes pointing outward toward ears), hypertropia (eyes drifting up or down), exophthalmos (one or more bulging eyes), and the like.

Thereafter, at step 188, the training module 84 directs the template generation module 88 to develop a biometric template from the segmented image and/or the iris and liveness authentication features identified by the feature extraction module 86 that is a mathematical representation of the features represented in the segmented image. At step 190, the template generation module 88 stores the biometric template and the imaging specification associated therewith in the template database 90. In some embodiments, the template generation module 88 may analyze the extracted iris features using, for example, a signal processing and/or low-level abstraction techniques that analyze the segmented image such as Gabor Filters, Wavelet Transforms, and the like that focus on specific aspects of the segmented image such as textures, patterns, edges, frequency components present in the segmented image, and the like to develop the biometric template. In some embodiments, the template generation module 88 may use deep learning methods and provide the segmented image (or the normalized image) to, for example, a convolutional neural network, that is trained to automatically extract iris characteristics from the segmented image and such extracted iris characteristics may comprise the biometric template. The biometric template may have embedded therein one or more of a numerical representation, a numerical vector encoding, a high-dimensional vector encoding, and the like that is unique to the iris image represented by such biometric template. In some embodiments, the biometric template may be further processed by the template generation module 88 to reduce dimensionality of the information (e.g., the number of features) embedded therein and thereby the storage needed to store of the biometric template and/or processing requirement to use the biometric template. In some embodiments, the template generation module 88 may use Principal Component Analysis and similar techniques apparent to one having skill in the art to reduce such dimensionality.

After, the training module 86 has developed and stored a plurality of biometric templates associated with the plurality of imaging specifications, the authentication module 92 of the BAS 50 operates as a background application whenever the computing device 50 is active and iteratively authenticates the operator of the computing device 50 to confirm that such operator is identical to the operator associated with the plurality of templates developed by the training module 86 and is alive.

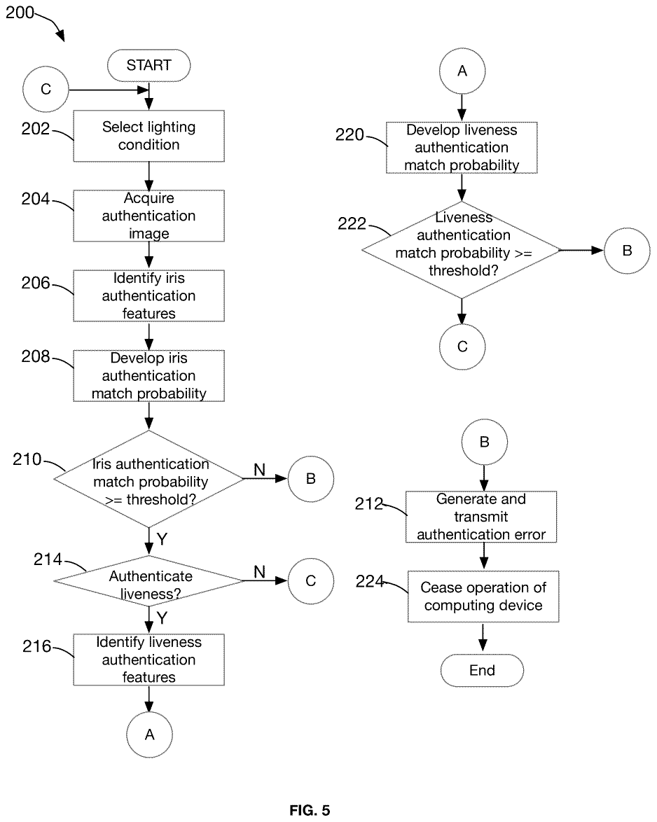

FIG. 5 is a flowchart 200 of processing undertaken by the authentication module 92. In some embodiments, the authentication module 92 undertakes such processing periodically. In some cases, the authentication module may periodically check if a face or an eye portion of a face is in the field of view of the image capture device 54 and undertake such processing. In addition, the authentication module 92 may undertake such processing if a user attempts to unlock the computing device 50 or attempts to access sensitive information stored on such device.

Referring to FIGS. 2 and 5, at step 202, the authentication module 92 randomly selects an imaging specification of the plurality of imaging specifications. Note, that in some embodiments, the imaging specification selected at step 202 need not be any of the imaging specifications created at step 154 (FIG. 3) to generate the biometric templates associated with the authorized user and as such, the imaging specification is randomly determined each time the identity and/or liveness of the user is authenticated. At step 204, the authentication module 92 directs the image acquisition module 82 to acquire an authentication image in accordance with the selected imaging specification. At step 206, the authentication module 92 directs the feature extraction module 84 to identify the iris authentication features of each iris represented in the authentication image. At step 210, the authentication module 92 directs the iris authentication module 96 to determine how well the iris authentication features identified in the authentication image match the iris authentication features encoded in the selected biometric template.

In some embodiments, each iris authentication feature identified in the authentication image is compared to the iris authentication features in the selected biometric template to determine if there is an iris authentication feature in the selected biometric template that has an identical type to that of the iris authentication feature in the authentication image and the shape, location, and dimensions of the two iris authentication features within the iris are within a predetermined acceptable error amount. The iris authentication module 96 may develop an iris authentication match probability in accordance with a number of the iris authentication features in the authentication image that have corresponding iris authentication features in the biometric template. The value of the iris authentication probability indicates a probability that the iris represented in the authentication image belongs to the same operator whose image was used to develop the selected biometric template. In some embodiments, the authentication module 92 may use the feature extraction module 84 and the template generation module 88 as described above to develop a candidate biometric template from the authentication image and then, at step 184, compare the candidate biometric template with the biometric templates stored in the templates data store 90 to determine the iris authentication probability. In some embodiments, the authentication module 92 may analyze the candidate biometric template and a reference biometric template (i.e., one of the biometric templates stored in the templates data store 90) and determine that variations in certain features (e.g., a variation in pupil size due to dilation or contraction, and the like) represented in the candidate and reference biometric templates are due to differences in local environmental conditions (e.g., lighting, dust, etc.) when images used to generate such templates were acquired. For example, in some embodiments, the authentication module 92 may use a neural network trained so that when the candidate biometric template and the reference biometric template are provided as inputs, the neural network generates one or more outputs that indicate a probability the two templates are associated with the same person taking into account variations in features that result from differences in the local environmental conditions. Such probability generated by the neural network may be incorporated into the authentication probability developed by the authentication module 92.

At step 210, the authentication module 92 determines if the value of the iris authentication probability value is at least a predetermined acceptable threshold value (i.e., the image acquired at step 204 is believed to be that of the authorized user), and if so proceeds to step 212. Otherwise, the authentication module 92 proceeds to step 214. In some embodiments, the predetermined acceptable threshold may vary in accordance with a level of security desired. In some embodiments, the predetermined acceptable threshold may be 85%. In some more secure applications, the predetermined acceptable threshold may be at least 92%.

In some embodiments, the authentication module 92 may develop a Euclidean distance, cosine similarity, and the like, to compare the features encoded in the candidate biometric template to those encoded in one or more biometric templates stored in the templates data store 90 at step 184. In such embodiments, the predetermined acceptable threshold may be, for example, a Euclidean distance between 0.3 and 1.0, wherein the predetermined acceptable threshold of 0.3 may be used in highly secure situations and of 1.0 may be used in less secure situations. Other types of metrics associated with the comparison and predetermined acceptable thresholds apparent to one who has ordinary skill in the art may be used in other embodiments.

At step 214, if the image acquired at step 204 is believed to be that of the authorized user, the authentication module 92 determines if the liveness of the operator of the computing device 50 should also be checked. In some embodiments, the liveness of the operator is checked each time the authentication image is acquired. In other embodiments, the authentication module 92 may check the liveness of the operator after a predetermined number of times the iris (i.e., identify) of the operator has been authenticated in order to reduce processing resources of the computing device 50 consumed to authenticate the operator thereof. If the liveness of the operator should be checked processing proceeds to step 216. Otherwise, processing proceeds to step 218.

At step 216, the authentication module 92 directs the feature extraction module 84 to identify liveness authentication features in the authentication image acquired at step 204. At step 220, the authentication module 92 directs the liveness authentication module 98 to determine a liveness probability value that indicates how well the dynamic features identified in the authentication image matched those encoded in the biometric template associated with the imaging specifications selected at step 202. At step 222, the authentication module 92 determines if the liveness probability value is at least a predetermined threshold value and, if so, returns to step 202 to randomly select another or the same imaging specification. Otherwise, the authentication module proceeds to step 212.

At step 212, the authentication module 92 generates and transmits to the remote server 100 a message that indicates that authentication of the operator of the computing device 50 has failed. Such message may further indicate whether iris authentication or liveness authentication failed and optionally include the authentication image acquired at step 202 that caused the failure. Thereafter, at step 224, the authentication module 92 ceases operation of the computing device 50.

In some embodiments, the computing device 50 may include one or more additional liveness checking device(s) 102 such as a heart rate monitor, a blood pressure monitor, a brain wave monitor, a facial tracking system, and the like. In such embodiments, the authentication module 92 may check signals and/or data generated by such liveness checking device(s) 102 in addition to checking the liveness authentication match probability at step 222 to confirm that such devices also indicate the operator is alive.

It should be apparent to those who have skill in the art that any combination of hardware and/or software may be used to implement components of the BAS 80 described herein. It will be understood and appreciated that one or more of the processes, sub-processes, and process steps described in connection with FIGS. 2-5 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules depicted in FIGS. 2-5 The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., processing device 58, the image acquisition module 82, the feature extraction module 84, the training module 86, the template generation module 88, the authentication module 92, the iris authentication module 92, and the liveness detection module 98), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

Depending on certain implementation requirements, the embodiments described can be implemented in hardware and/or in software. The implementation can be performed using a non-transitory storage medium such as a digital storage medium, for example, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the present disclosure comprise a data carrier having electronically readable control signals, which are capable of cooperating with a processor, a controller, or a programmable computer system, such that one of the methods described herein is performed.

Generally, embodiments disclosed herein can be implemented as a computer program product with a program code, the program code being operative for performing one of the methods when the computer program product runs on a computer. The program code may, for example, be stored on a machine-readable carrier.

Other embodiments comprise the computer program for performing one of the methods described herein, stored on a machine-readable carrier.

In other words, an embodiment, therefore, may include a computer program having a program code for performing one of the methods described herein, when the computer program runs on a processor, a controller, and/or a computer.

A further embodiment of the system described herein is, therefore, a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitory. A further embodiment of the present invention is an apparatus as described herein comprising a processor and the storage medium.

A further embodiment of the system describe herein is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

I claim:

1. A biometric authentication system for a computing device, comprising:
a light emitter;
an imaging device; and
a controller comprising a processor and memory architecture and configured to:
randomly select an imaging specification from a plurality of previously generated imaging specifications, wherein each of the plurality of previously generated imaging specifications specifies a quantity of emissions by the light emitter, an intensity and duration associated with each emission, and an interval free of emission following each emission, all of which are randomly determined;
operate the light emitter to emit the quantity of emissions in accordance with the selected imaging specification;
acquire using the imaging device an authentication image of an operator of the computing device after operation of the light emitter is completed; and
analyze the authentication image in accordance with a previously developed biometric template associated with the selected imaging specification to determine if the authentication image and the biometric template are both associated with the operator.

2. The biometric authentication system of claim 1, wherein the controller iteratively selects a subsequent imaging specification randomly, operates the light emitter in accordance with the subsequent imaging specification, acquires a subsequent authentication image, and analyzes the subsequent authentication image while the computing device is being operated.

3. The biometric authentication system of claim 2, wherein controller is further configured to analyze the authentication image to confirm liveness of the operator.

4. The biometric authentication system of claim 3, wherein the device includes one or more of a heart rate monitor, a blood pressure monitor, a brain wave monitor, a facial tracking system, and the controller is configured to confirm liveness of the operator in accordance with data generated by the one or more of the heart rate monitor, blood pressure monitor, facial tracking system, and the brain wave monitor.

5. The biometric authentication system of claim 1, wherein the controller is configured to develop a plurality of biometric templates from a corresponding plurality of training images of an authorized operator, wherein each of the plurality training images is acquired in accordance with a corresponding one of the plurality of imaging specifications.

6. The biometric authentication system of claim 5, wherein the plurality of biometric templates are stored in a trust zone of the computing device.

7. The biometric authentication system of claim 5, wherein each biometric template encodes features of at least one iris represented in a training image.

8. The biometric authentication system of claim 1, wherein the near infrared emitter, the imaging device, and the controller are components of or are coupled to one of a mobile device or a desktop computer.

9. The biometric authentication system of claim 1, wherein the controller is configured to generate and transmit a message to a further computing device if controller determines the authentication image and the biometric template are not associated with the operator, and then cease operation of the computing device.

10. A method of biometric authentication of an operator of a computing device, comprising:
randomly selecting an imaging specification from a plurality of previously generated imaging specifications, wherein each of the plurality of previously generated imaging specifications specifies a quantity of emissions by a light emitter, an intensity and duration of each emission, and an interval free of emission following each emission, all of which are randomly determined;
operating the light emitter to emit the quantity of emissions in accordance with the selected imaging specification;
using an imaging device to acquire an authentication image after operation of the light emitter in accordance with the selected imaging specification is completed; and
analyzing the authentication image in accordance with a previously developed biometric template associated with the selected imaging specification to determine if the authentication image and the biometric template are both associated with the operator.

11. The method of claim 10, wherein the controller iteratively undertakes selecting a subsequent imaging specification randomly, operating the light emitter in accordance with the selected imaging specification, acquiring a subsequent authentication image, and analyzing the subsequent authentication image while the computing device is being operated.

12. The method of claim 11, further including analyzing the authentication image to confirm liveness of the operator.

13. The method of claim 12, further including confirming liveness of the operator in accordance with data generated by one or more of a heart rate monitor, a blood pressure monitor, a facial tracking system, and a brain wave monitor coupled to the computing device.

14. The method of claim 10, further including acquiring a plurality of training images of an authorized operator and developing a plurality of biometric templates from corresponding ones of the plurality of training images, wherein each of the plurality training images is acquired in accordance with an associated one of the plurality of imaging specifications.

15. The method of claim 14, further including storing the plurality of biometric templates in a trust zone of the computing device.

16. The method of claim 14, wherein each biometric template encodes features of at least one iris represented in a training image.

17. The method system of claim 10, wherein the near infrared emitter, the imaging device, and the controller are components of or are coupled to one of a mobile device or a desktop computer.

18. The method of claim 10, further including generating and transmitting a message to a further computing device if the authentication image and the biometric template are not associated with the operator, and then ceasing operation of the computing device.
